(19) United States
(12) Patent Application Publication
(10) Pub. No.: US 2013/0141772 A1
(43) Pub. Date: Jun. 6, 2013

(54) Sensitivity Improvement of Mach-Zehnder Modulator Bias Control

(71) Applicant: Futurewei Technologies, Co., Plano, TX (US)

(72) Inventor: Zhiping Jiang, Kanata (CA)

(73) Assignee: FUTUREWEI TECHNOLOGIES, CO., Plano, TX (US)

(21) Appl. No.: 13/650,356

(22) Filed: Oct. 12, 2012

Related U.S. Application Data
(60) Provisional application No. 61/566,432, filed on Dec. 2, 2011.

(51) Int. Cl. G02F 1/01

(52) U.S. Cl. 359/276; 359/279

(57) ABSTRACT

An apparatus comprising a circuit configured to couple to a nested Mach-Zehnder modulator (MZM), the circuit configured to receive a first signal proportional to a sum of an in-phase (I) component and a quadrature (Q) component, receive a second signal that is proportional to a difference between the I component and the Q component, and generate a difference signal as a difference in intensity between the first signal and the second signal, and a controller configured to provide a bias signal to the nested MZM to control a phase difference between the I component and the Q component, wherein the bias signal is based on the difference signal.

### CROSS-REFERENCE TO RELATED APPLICATIONS

The present application claims priority to U.S. Provisional Patent Application No. 61/566,432 filed Dec. 2, 2011 by Zhiping Jiang and entitled “Sensitivity Improvement of Mach-Zehnder Modulator Bias Control”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In some optical communications networks, optical signals are modulated using a Mach-Zehnder modulator (MZM). A MZM is a device that splits a beam into two paths, adds a relative phase shift between the two paths, and recombines the paths into one path. The MZM may be used to generate amplitude or phase modulated signals. A nested MZM, comprising two parallel inner MZMs in each path of the nested MZM, may be used to implement digital amplitude or phase modulation, such as quadrature amplitude modulation (QAM) or phase shift keying (PSK), by splitting a light source into an in-phase (I) signal component and a quadrature phase (Q) signal component at a π/2 phase difference (in radians, or 90 degrees) from the in-phase component. Maintaining this π/2 phase difference between the two components is important to achieve successful and reliable modulation. The π/2 phase difference may cause a minimum radio frequency (RF) (i.e., alternating current (AC) component of the signal) power as measured at an output of the nested MZM. The I component and Q component phase difference control can be realized via detecting and minimizing the RF power at an output. As such, an approximate π/2 phase difference may be maintained sufficiently for QAM or PSK by maintaining the RF output power at minimum value.

However, for modulation formats, such as QAM, or for quadrature PSK (QPSK) with a dispersion pre-compensation scheme, the output RF power increases and varies more slowly around the π/2 phase difference. The higher-order modulation formats and dispersion pre-compensation scheme are used to improve optical communications and achieve higher signal to noise ratios and/or data rates. This causes the RF power to be less sensitive to phase difference variation, and thus the RF power versus phase difference pattern has a more rounded or flat bottom instead of a sharp dip at the π/2 phase difference value. The power values at the bottom may also be higher in the case of higher modulation formats or when using a dispersion pre-compensation scheme. A shallower bottom pattern of the RF power may also be caused by optical intensity fluctuation due to the higher modulation formats or dispersion pre-compensation scheme. The shallower bottom pattern makes it difficult to determine the minimum RF power in order to realize the π/2 phase difference, which can reduce quality of communications. Accordingly, methods and apparatuses to more accurately generate a π/2 phase difference between the I and Q components are desirable.

### SUMMARY

In one embodiment, the disclosure includes an apparatus comprising a circuit configured to couple to a nested MZM, the circuit configured to receive a first signal proportional to a sum of an I component and a Q component, receive a second signal that is proportional to a difference between the I component and the Q component, and generate a difference signal as a difference in intensity between the first signal and the second signal, and a controller configured to provide a bias signal to the nested MZM to control a phase difference between the I component and the Q component, wherein the bias signal is based on the difference signal.

In another embodiment, the disclosure includes an apparatus comprising a nested MZM configured to generate a first signal comprising a sum of an I component and a Q component, generate a second signal comprising a difference of the I component and the Q component, and receive a bias signal that biases a phase difference between the I component and the Q component, and a circuit coupled to the nested MZM and configured to receive the first signal and the second signal, generate a first intensity signal that represents an intensity of the first signal, generate a second intensity signal that represents an intensity of the second signal, and compute a difference signal comprising a difference between the first intensity and the second intensity, wherein the bias signal is based on the difference signal.

In yet another embodiment, the disclosure includes a method for controlling a phase difference between an I component and a Q component in a nested MZM, the method comprising receiving a first signal from the nested MZM comprising a sum of the I component and the Q component, receiving a second signal comprising a difference between the I component and the Q component, generating a first intensity signal that represents an intensity of the first signal, generating a second intensity signal that represents an intensity of the second signal, computing a difference signal comprising a difference between the first intensity and the second intensity, and generating a control signal to control the phase difference, wherein the control signal is based on the difference signal.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a typical MZM apparatus.

FIG. 2 illustrates simulated results of relative RF power versus phase difference for QPSK and 16 QAM using a typical MZM apparatus.

FIG. 3 illustrates empirical results of relative RF power versus phase difference for QPSK and 16 QAM using a typical MZM apparatus.

FIG. 4 illustrates simulated results of relative RF power versus phase difference for QPSK with increased dispersion pre-compensation using a typical MZM apparatus.

FIG. 5 illustrates empirical results of relative RF power versus bias voltage using a typical MZM apparatus.

FIG. 6 is a schematic diagram of a MZM apparatus according to an embodiment of the disclosure.

FIG. 7 is a schematic diagram of a MZM apparatus according to another embodiment of the disclosure.

FIGS. 8A and 8B illustrate simulated results of relative RF power terms versus phase difference for QPSK with increased dispersion pre-compensation using a MZM apparatus according to an embodiment of the disclosure.

FIGS. 9A and 9B illustrate simulated results of relative RF power terms versus phase difference for 16 QAM with increased dispersion pre-compensation using a MZM apparatus according to an embodiment of the disclosure.

FIG. 10 is a flowchart of a method for nested MZM phase difference control according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

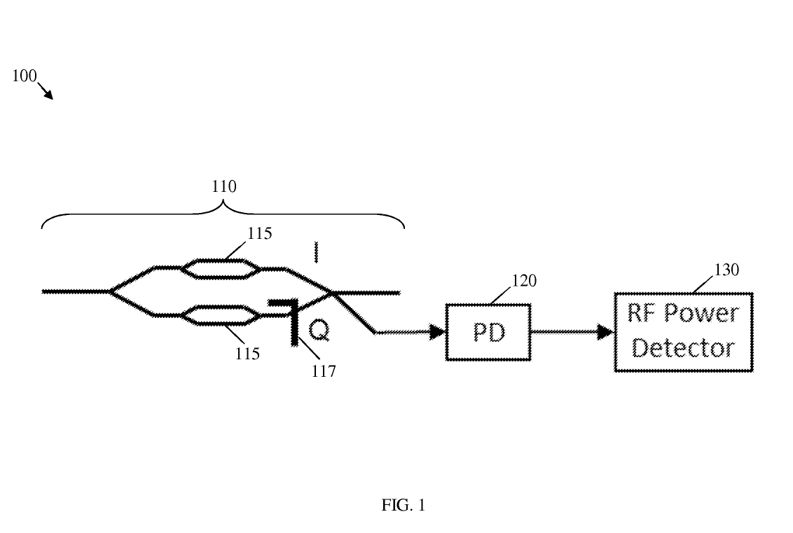

FIG. 1 illustrates a conventional MZM apparatus 100, which may be used in optical systems. The MZM apparatus may be used to modulate and transmit optical data in QPSK or QAM formats, e.g., for optical communication systems. The MZM apparatus 100 may comprise a nested MZM 110, a photodiode (PD) 120 coupled to an output of the nested MZM 110, and a radio frequency (RF) power detector 130 coupled to the PD 120 as shown in FIG. 1. The nested MZM 110 may comprise two MZMs 115 arranged in parallel, where the upper branch may be an in-phase or I branch and the lower branch may be a quadrature or Q branch as illustrated. The nested MZM 110 may also comprise a phase control electrode 117 that allows for control of the phase of the Q branch of the nested MZM 110, the phase of the I branch, or the phase difference between the I and Q branches. The net effect of a signal applied to the phase control electrode 117 is that the phase difference of the I and Q branches is controlled. Thus, the phase control electrode 117 thus provides a mechanism for controlling the phase difference between the I and Q branches. The nested MZM 110 may be configured to receive light from an optical source (not shown), e.g., a laser or diode, split the light into two paths and introduce a phase difference in the light between the two paths, for instance to achieve a π/2 phase difference. The light in the two paths may be modulated to obtain I and Q components that correspond to the two paths. The nested MZM 110 may comprise two arms that correspond to the two paths and means for applying bias or voltage, such as electrically, to the two arms to cause a phase delay in the light between the two arms or paths, and hence a phase difference between the I and Q components. Typically, the introduced phase difference may be equal to about π/2 to guarantee improved detection (on the other side) and signal quality.

The PD 120 may be configured to receive an output from the nested MZM 110 convert the optical signal into an electrical signal for detection purposes, where the current of the electrical signal is proportional to the power of the optical signal. The MZM may have two output ports, where one is used to transmit an output data signal (the combined I and Q components), and a second port to provide a similar signal to the PD 120. The RF power detector 130 may be configured to measure the RF power in the electrical signal at the output of the PD 120 in order to measure the RF power of the nested MZM output. This may require a calibration process before measuring the RF power. The measured RF power may be used to determine the amount of bias needed to adjust or maintain the desired phase difference at the MZM 110 output, i.e., the π/2 phase difference between the I and Q components. An output from the RF power detector 130 may be used to control a bias at phase control electrode 117. For instance, if the measured signal is not at a minimum RF power, then bias may be adjusted until the measured RF power reaches the minimum. This control process may be applied continuously while the MZM 110 emits signals. The RF power detector 130 may filter any direct current (DC) or low-frequency components from the output of the PD 120 and therefore yield a power measurement of the output of the PD 120 only in a desired range of radio frequencies.

The MZM apparatus 100 and the associated control scheme may be suitable when relatively low-order modulation formats are used, such as QPSK or QAM. However, when higher-order modulations are used, such as 16 QAM, or when a dispersion pre-compensation scheme is applied, for example with QPSK modulation, then optical intensity fluctuation in the transmitted signals may be more substantial. More substantial fluctuation in the optical intensity at the output makes it more difficult to determine the minimum RF power and control or maintain the π/2 difference between the I and Q components, which may in turn reduce signal quality. Different MZM IQ bias control schemes have been proposed. Such schemes suffer lower sensitivity with higher-order QAM or with dispersion pre-compensation, are complicated and in some cases are not suitable for use with dispersion pre-compensation, or are still in the trial phases.

Disclosed herein are systems, apparatuses, and methods for effective phase control of a MZM output for optical systems. A phase difference between the I and Q components of the MZM output may be effectively maintained at approximately π/2 and controlled by improving the RF power sensitivity to the phase difference between the I and Q components, which may facilitate and/or improve phase or phase difference control. The improved sensitivity of RF power to the phase difference may be achieved by eliminating optical intensity fluctuation in the detected power signal for bias control feedback. The optical intensity fluctuation may be significant at higher modulation formats and/or in the case of using dispersion pre-compensation, which may cause a reduced sensitivity in the RF power output to phase difference, i.e., a shallower bottom in the RF power versus phase difference pattern. The optical intensity fluctuation may be eliminated by detecting the optical intensity difference between outputs of a nested MZM as described further below.

By eliminating the common mode intensity fluctuation, the detected power signal, which is used for feedback to control the bias voltage, may become substantially correlated with the IQ phase difference of the MZM output. This may result in a better pronounced minimum in the RF power output at the π/2 phase difference value, and thus facilitate detecting the minimum to maintain the π/2 phase difference and improve output signal quality. This MZM modulation scheme may substantially increase the control sensitivity, and may be used in any digital amplitude modulation or digital phase modulation format with or without dispersion pre-compensation or distortion pre-compensation.

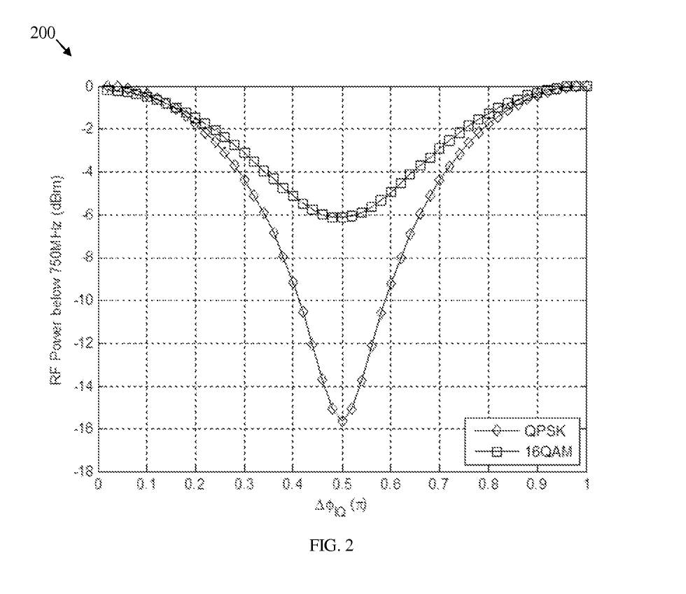

FIG. 2 shows a graph 200 that represents simulated RF power values (y-axis) versus a range of phase difference values (x-axis) for QPSK and 16 QAM formats for a typical MZM apparatus, such as the MZM apparatus 100. The values may be obtained via computer simulations that model the operation of the MZM apparatus. The RF power bandwidth is below 750 Megahertz (MHz). The graph 200 comprises a first curve of RF power versus IQ phase difference (Δφ_{IQ}) for QPSK modulation (indicated using diamond markers) and a second curve for 16 QAM modulation (indicated using square markers). The RF power values (on the y-axis) are shown in decibel milliwatt (dBm) and the IQ phase difference values are shown as multiples of π. The curves show a dip that reflects a pronounced minimum in RF power in the case of the relatively low modulation format QPSK, and a shallower bottom in the RF power in the case of the higher modulation format 16 QAM. In the case of the 16 QAM modulation the RF power curve is said to be less sensitive to phase difference variation and the minimum phase difference may be more difficult to detect in this case. Thus, maintaining the minimum RF power to maintain a π/2 IQ phase difference may be more difficult in the case of the 16 QAM modulation in comparison to the QPSK modulation.

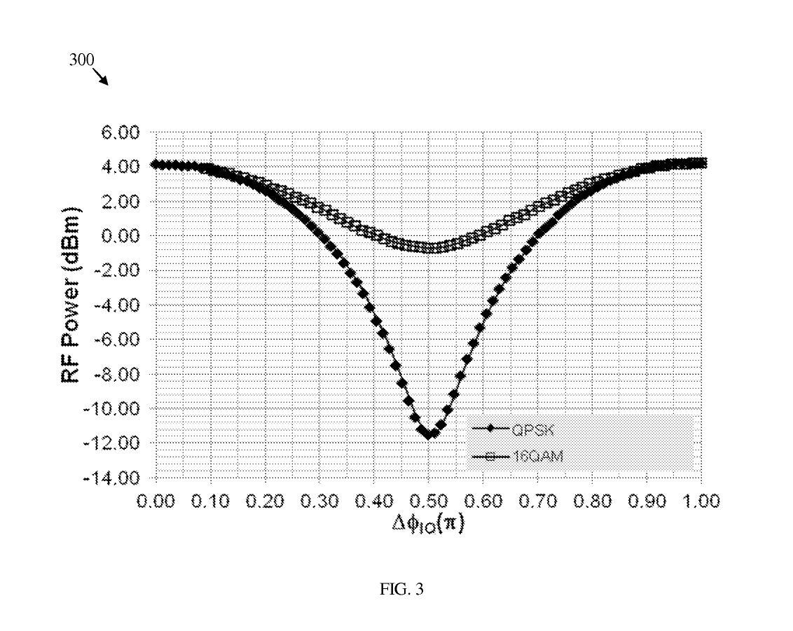

FIG. 3 shows a graph 300 that represents empirical RF power values (y-axis) versus a range of phase difference values (x-axis) for QPSK and 16 QAM formats for a typical MZM apparatus, such as the MZM apparatus 100. The empirical values may be obtained experimentally using the MZM apparatus. The graph 300 comprises a first curve of RF power versus IQ phase difference for QPSK modulation (indicated using diamond markers) and a second curve for 16 QAM modulation (indicated using square markers). The RF power values (on the y-axis) are shown in dBm and the IQ phase difference values are shown as multiples of π. Similar to the graph 200 for the simulated values for QPSK and 16 QAM modulation formats above, the experimental curves of the graph 300 show a dip that reflects a pronounced minimum in RF power in the case of the relatively lower modulation format QPSK, and a shallower bottom in the RF power in the case of the higher modulation format 16 QAM.

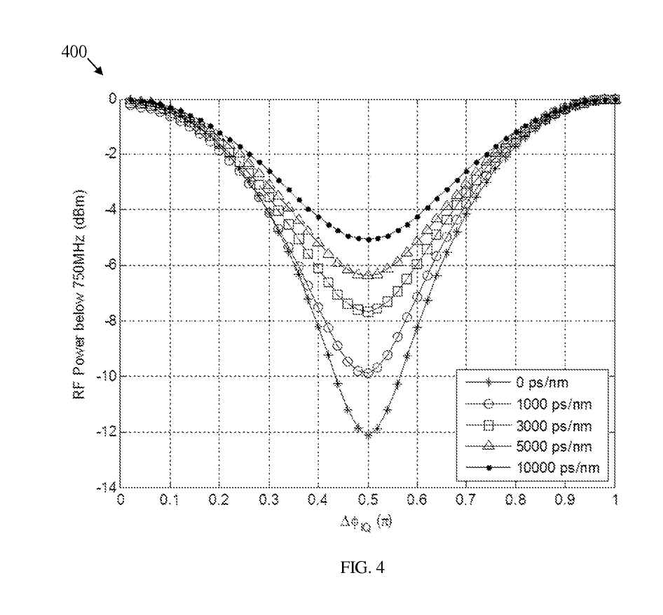

FIG. 4 shows a graph 400 that represents simulated RF power values (y-axis) versus a range of phase difference values (x-axis) for QPSK formats with varying dispersion pre-compensation levels for a typical MZM apparatus, such as the MZM apparatus 100. The RF power bandwidth is below 750 MHz. The values may be obtained via computer simulations that model the operation of the MZM apparatus. The graph 400 comprises a first curve of RF power versus IQ phase difference (Δφ_{IQ}) for QPSK modulation without dispersion pre-compensation (indicated using star markers). The graph 400 also comprises four additional curves for four dispersion pre-compensation levels of 1,000 picosecond per nanometer (ps/nm) (indicated using circle markers), 3,000 ps/nm (indicated using square markers), 5,000 ps/nm (indicated using triangle markers), and 10,000 ps/nm (indicated using dot markers). The RF power values (on the y-axis) are shown in dBm and the IQ phase difference values are shown as multiples of π. The curves show a dip that reflects a pronounced minimum in RF power in the case of the QPSK format without dispersion pre-compensation, and increasingly shallower bottoms in the RF power as the dispersion pre-compensation level increases. This is clear where the curve corresponding to the highest dispersion of 10,000 ps/nm (indicated using dot markers) shows the shallower bottom. This reduced sensitivity in the RF power curve with respect to the phase difference indicates that maintaining the minimum RF power to maintain a π/2 IQ phase difference may become more difficult for QPSK modulation as dispersion pre-compensation increases.

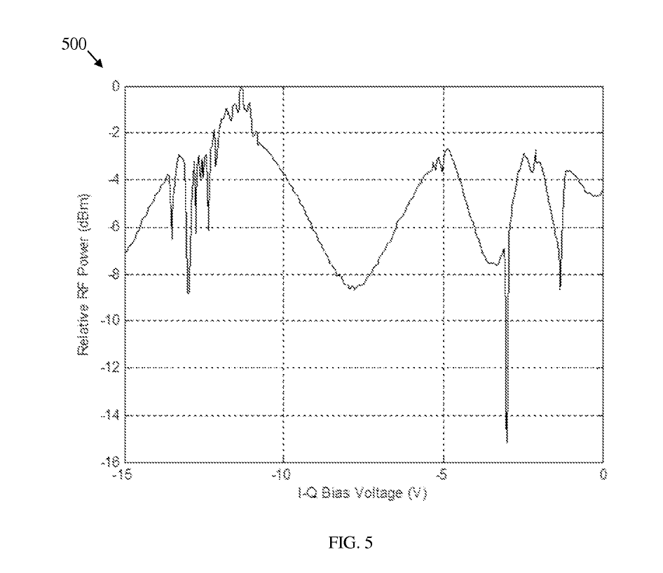

FIG. 5 shows a graph 500 that represents empirical RF power values (y-axis) versus an IQ bias voltage range for 16 QAM modulation for a typical MZM apparatus, such as the MZM apparatus 100. The empirical values may be obtained experimentally using an MZM apparatus, such as the MZM apparatus 100. The graph 500 comprises a curve of relative RF power versus IQ bias voltage that may be applied to maintain a desired IQ phase difference in the MZM output, i.e., a π/2 phase difference. The relative RF power values (on the y-axis) are shown in dBm and the IQ bias voltage values are shown in volts. The curve comprises random and abrupt (non-smooth) fluctuations or dips in the relative RF power along the IQ bias voltage range that are due to optical intensity fluctuation in the output. The IQ phase difference may be proportional to the IQ bias voltage and a similar behavior of relative RF power versus IQ phase difference is expected. The optical intensity of the combined I and Q signal may be represented mathematically as:

I(t)=|E_{I}(t)|²+|E_{Q}(t)|²+2E_{I}(t)E_{Q}(t)cos(θ), (1)

where t is a time parameter, E_{I} is the I component, E_{Q} is the Q component, and θ is the phase difference between the I and Q components.

A goal of the control process is to set the phase difference θ to π/2. In order to achieve this value of phase difference, the RF power of I(t) may be measured. The RF power of I (t) may be proportional to the variance of I (t). The variance of I(t) has two contributions −(1) a contribution from the variance of |E_{I}(t)|²+|E_{Q}(t)|²; and (2) a contribution from the variance of 2E_{I}(t)E_{Q}(t)cos(θ). The second contribution comprises the signal component of interest in minimizing the RF power. A target is to minimize the second contribution, while the first contribution acts as interference in this minimization. Novel techniques are presented herein to substantially eliminate the effects of the first contribution in the minimization.

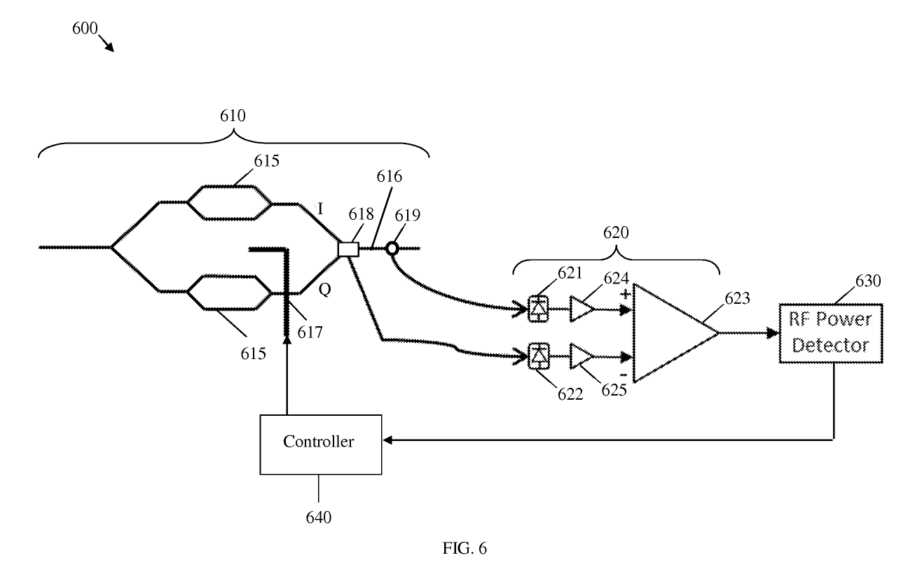

FIG. 6 illustrates a MZM apparatus 600 according to an embodiment of the disclosure. The MZM apparatus 600 may have improved phase control and control sensitivity in comparison to a typical MZM apparatus, such as the MZM apparatus 100, and may be suitable for amplitude or phase modulation formats, such as QPSK or 16 QAM, and/or when using dispersion pre-compensation. The MZM apparatus 600 may comprise a nested MZM 610, a difference circuit 620, and a RF power detector 630 configured as shown in FIG. 6. The nested MZM 610 may be configured similar to the MZM 110 and the RF power detector 630 may be configured similar to the RF power detector 130. For example, the nested MZM 610 may comprise two MZMs 615 connected in parallel, where the upper branch may be an in-phase or I branch and the lower branch may be a quadrature or Q branch as illustrated. The nested MZM 610 may also comprise a phase control electrode 617 that allows for control of the phase of the quadrature branch of the nested MZM 610.

The MZM apparatus 600 may also comprise a two-by-two coupler 618 configured to output the sum of the signals at the outputs of the two MZMs 615 onto an optical line 616 and the difference of the signals at the outputs of the two MZMs 616 onto an optical line connected to PD 622 as shown. Further, the MZM apparatus 600 may comprise a splitter 619.

The difference circuit 620 may comprise a first PD 621 coupled to the two-by-two coupler 618, a second PD 622 coupled to the splitter 619, and an operational amplifier (op-amp) 623 coupled to both the first PD 621 and the second PD 622. An output the splitter 619 may be used as the output of the MZM for data transmission purposes. The difference circuit 620 may comprise a first amplifier 624 positioned between the first PD 621 and the op-amp 623 and a second amplifier 625 positioned between the second PD 622 and the op-amp 623. The first PD 621 and the second PD 622 may be configured to convert the optical signals form the coupler 618 and the splitter 619, respectively, to electrical signals. The first amplifier 624 and the second amplifier 625 may be configured to match the gain or power level in the first and second converted electrical signals from the first PD 621 and the second PD 622, respectively. The op-amp 623 may be configured to output to the RF power detector 630 the difference between the first and second converted electrical signals.

The first PD 621 and the second PD 622 may detect the optical intensities of the first and second optical signals from the first 618 and second 619 ports, respectively, of the MZM 610. The corresponding first and second optical intensities may be represented mathematically as:

I₁(t)=α₁[|E_{I}(t)|²+|E_{Q}(t)|²+2E_{I}(t)E_{Q}(t)cos(θ)], (2)

and

I₂(t)=α₂[|E_{I}(t)|²+|E_{Q}(t)|²−2E_{I}(t)E_{Q}(t)cos(θ)], (3)

where E_{I}(t) is the I component, E_{Q}(t) is the Q component, θ is the phase difference between the I and Q components (which is ideally π/2), I₁(t) is the first optical intensity of a first optical signal at the output of coupler 618 provided to PD 622, I₂(t) is the second optical intensity of a second optical signal at the output of splitter 619 provided to PD 621, α₁ is a relative output gain of first optical signal, and α₂ is a relative output gain of second optical signal. To substantially reduce or eliminate the optical intensity fluctuation due to the term |E_{I}(t)²+|E_{Q}(t)|², the op-amp 623 may receive the converted electrical signals proportional to I₁(t) and I₂(t) and output the difference between the two, which may be represented as:

ΔI(t)≡I₁(t)−I₂(t)∝γ(|E_{I}(t)|²+|E_{Q}(t)|²)+2E₁(t)E_{Q}(t)cos(θ), (4)

where γ=α₁−α₂ is a relative gain of the difference output signal from the op-amp 623, ΔI(t). When γ is equal to zero or is about zero, then contribution from the term |E_{I}(t)|²+|E_{Q}(t)|² is completely cancelled or is negligible. A reason why γ may not equal zero is due to system imperfections. The gains of amplifiers 624 and 625 may be adjusted to make γ close to zero to eliminate the contribution of term |E_{I}(t)|²+|E_{Q}(t)|². Thus, the RF power in the signal at the output of op-amp 623, as measured by RF power detector 630, may be substantially proportional to cos²(θ), which is a periodic function of the phase difference between the I and Q components. Further, in this case, ΔI(t) may reach a minimum at about zero (or zero if γ is equal to zero) at a phase difference of π/2. Note that the RF power detector 630, in producing an output measurement of the RF power, may block any DC components introduced by upstream components, such as the op-amp 623.

In the scheme above, γ may determine the performance of the phase control using the MZM apparatus 600. The smaller the γ value, the better is the RF power versus phase difference pattern, where a more pronounced minimum (i.e., closer to zero) may be found at the π/2 value. Additionally, the time delay between the two signal paths may need to be adjusted appropriately. For example, in the case of a 500 MHz RF power bandwidth, the time delay requirement may be less than 2 nanosecond (ns).

In other embodiment, the optical intensity fluctuation in the detected power signal for bias control feedback may be eliminated or substantially reduced using an optical apparatus or circuit instead of the difference circuit 620. The optical apparatus or circuit may receive the two optical intensities I₁(t) and I₂(t) and provide the difference in intensity ΔI(t) using optical signal processing and optical components (instead of the electrical signal processing and electrical components of the difference circuit 620). The resulting intensity difference ΔI(t) may then be sent, converted, and processed in the RF power detector 630 in electrical signal form.

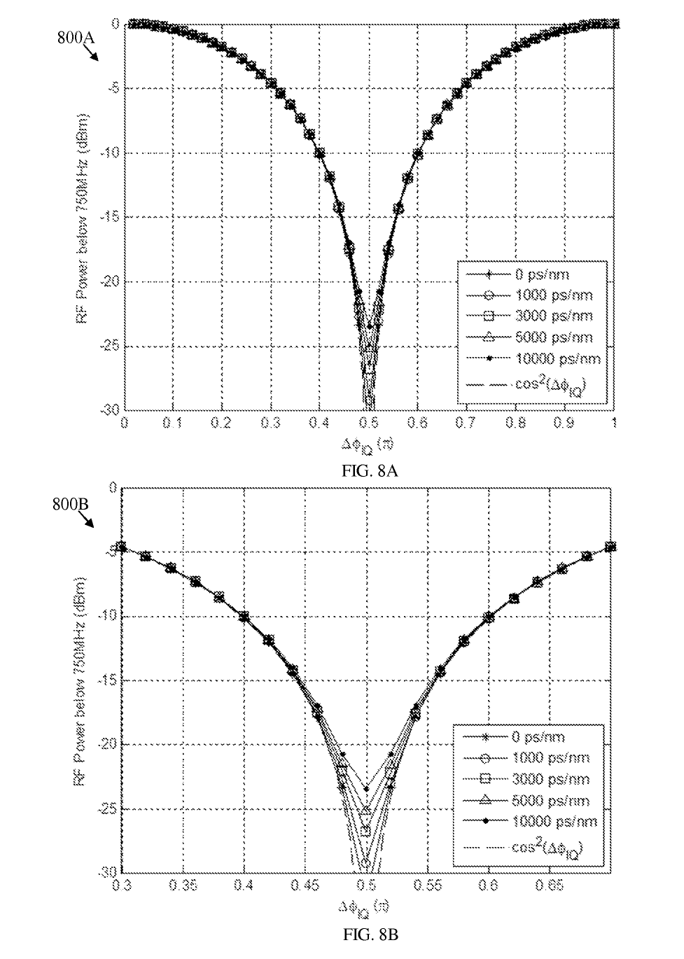

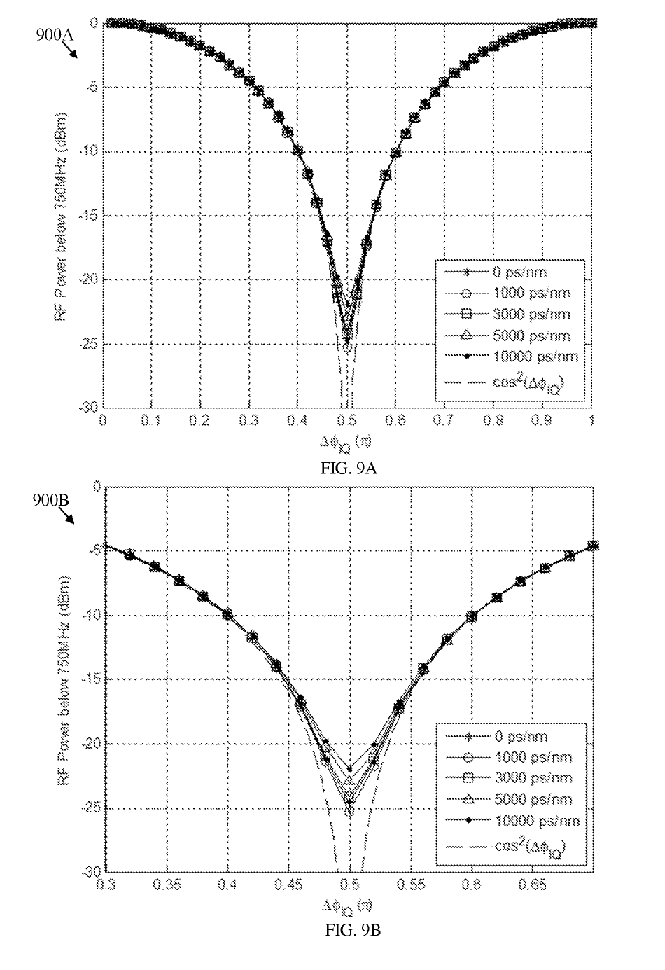

Finally, as appreciated by one of skill in the art, the MZM apparatus 600 may further comprise a controller 640 for receiving an output from the RF power detector 630 and providing a bias control signal to the phase control electrode 617, wherein controller is configured achieve a minimum RF power in ΔI(t). As appreciated by one of skill in the art, the controller 640 may be designed to achieve a minimum RF power in ΔI(t) using algorithms known to achieve minimum values of functions, wherein RF power in ΔI(t) is understood to have characteristics illustrated by FIGS. 8A, 8B, 9A, and 9B discussed below. For example, the controller 640 may be the same as a controller (not shown) used for the typical MZM apparatus 100 of FIG. 1. For example, the controller 640 may be configured to drive θ to a value of π/2. The difference circuit 620, RF power detector 630, and controller 640 form a feedback control loop to control the phase difference θ.

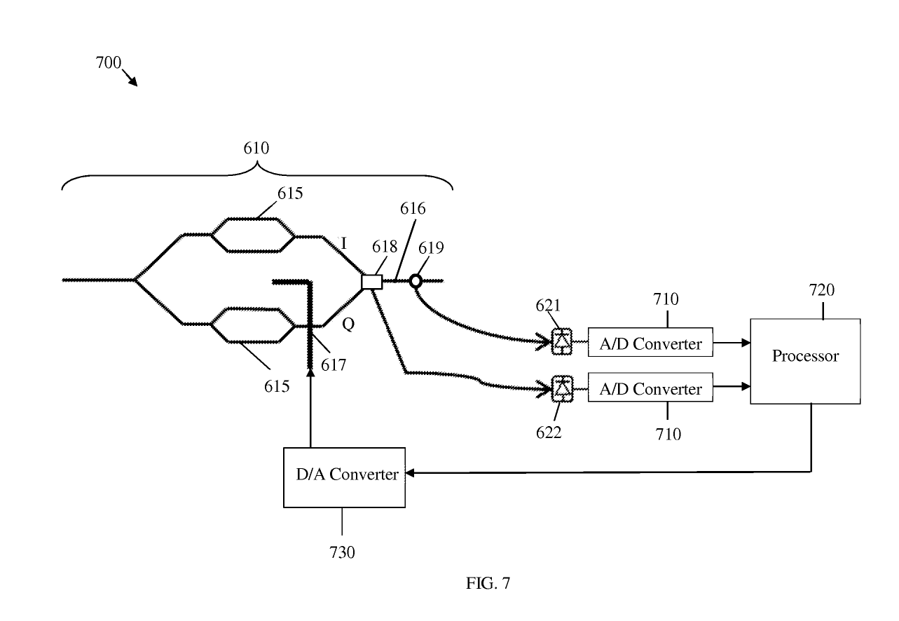

FIG. 7 illustrates a MZM apparatus 700 according to another embodiment of the disclosure. The MZM apparatus 700 may have improved phase control and control sensitivity in comparison to a typical MZM apparatus, such as the MZM apparatus 100, and may be suitable for amplitude or phase modulation formats, such as QPSK or 16 QAM, and/or when using dispersion pre-compensation. The MZM apparatus 700 may comprise a nested MZM 610 and PDs 621 and 622 as discussed with respect to FIG. 6. However, the MZM apparatus 700 may replace analog components of MZM apparatus 600 with digital components as shown. The output of PD 621 may be input to an analog-to-digital (A/D) converter 710, and the output of PD 622 may be input to an A/D converter 710 as shown. Further, the digital signals from A/D converters 710 may be input to a processor 720 that may implement the functionality of op-amp 623, RF power detector 630, and controller 640 in the digital domain. Although illustrated as a single processor, the processor 720 may be implemented as one or more CPU chips, cores (e.g., a multi-core processor), field-programmable gate arrays (FPGAs), application specific integrated circuits (ASICs), and/or digital signal processors (DSPs). The processor 720 may be a general-purpose processor that has been programmed with instructions to perform which effectively makes processor 720 a special-purpose processor. The output of processor 720 may be a bias control signal, which when converted to an analog signal by the digital-to-analog (D/A) converter 730, may be input to the phase control electrode 617 to control the phase difference between the I and Q components of the nested MZM 610.

FIG. 8A shows a graph 800A that represents simulated RF power values (y-axis) versus a range of phase difference values (x-axis) for QPSK modulation with varying dispersion pre-compensation levels using a MZM apparatus that eliminates or substantially reduce optical intensity fluctuation in the detected power signal for bias control feedback, for instance using the MZM apparatus 600 or a similar apparatus that generates the intensity difference ΔI(t) via optical processing. The RF power bandwidth is below 750 MHz. The values may be obtained via computer simulations that model the operation of the MZM apparatus. The graph 800A comprises a first curve of the RF power term cos²(θ) versus IQ phase difference (Δφ_{IQ}) for QPSK modulation without dispersion pre-compensation (indicated using dashed lines). The graph 800A also comprises a second curve of the term ΔI(t) in equation (4) versus IQ phase difference (Δφ_{IQ}) without dispersion pre-compensation, i.e., at 0 ps/nm (indicated using star markers).

The graph 800A also comprises four additional curves of the term ΔI(t) in equation (4) versus IQ phase difference (Δφ_{IQ}) for four dispersion pre-compensation levels of 1,000 picosecond ps/nm (indicated using circle markers), 3,000 ps/nm (indicated using square markers), 5,000 ps/nm (indicated using triangle markers), and 10,000 ps/nm (indicated using dot markers). The intensity values (on the y-axis) are shown in dBm and the IQ phase difference values are shown as multiples of π. The curves show a dip that reflects a pronounced minimum in RF power in all dispersion pre-compensation levels. The minimum for all levels is also close to the minimum zero in the case of the first curve for the term cos²(θ), which may be ideally achieved when γ in equation (4) is zero. This indicates that using the term ΔI(t) of equation (4) for bias control feedback may be suitable for QPSK modulation with varying dispersion pre-compensation levels due to the improved control sensitivity of the term ΔI(t), i.e., the presence of a pronounce minimum close to zero at π/2 phase difference.

FIG. 8B shows a graph 800B that comprises the same curves of the graph 800A, but at a closer range at the bottom of the y-axis to show more clearly the dips of the six curves above. The sensitivity of the curves above using the term ΔI(t) for QPSK with dispersion pre-compensation may be higher than the sensitivity using the RF power for QPSK without dispersion pre-compensation, i.e., the curve represented by the diamond marked curve in in FIG. 2. The bottom of the RF power curve in FIG. 2 for QPSK without dispersion pre-compensation is shallower than the curves in FIGS. 8A and 8B, which indicates lower sensitivity to the phase difference Δφ_{IQ} in FIG. 2, i.e., more difficulty in reaching or maintaining the π/2 phase difference value at the minimum of the curve.

FIG. 9A shows a graph 900A that represents simulated RF power values (y-axis) versus a range of phase difference values (x-axis) for 16 QAM modulation with varying dispersion pre-compensation levels using a MZM apparatus that eliminates or substantially reduce optical intensity fluctuation in the detected power signal for bias control feedback, for instance using the MZM apparatus 600 or a similar apparatus that generates the intensity difference ΔI(t) via optical processing. The RF power bandwidth is below 750 MHz. The values may be obtained via computer simulations that model the operation of the MZM apparatus. The graph 900A comprises a first curve of the RF power term cos²(θ) versus IQ phase difference (Δφ_{IQ}) for QPSK modulation without dispersion pre-compensation (indicated using dashed lines). The graph 900A also comprises a second curve of the term ΔI(t) in equation (4) versus IQ phase difference (Δφ_{IQ}) without dispersion pre-compensation, i.e., at 0 ps/nm (indicated using star markers).

The graph 900A also comprises four additional curves of the term ΔI(t) in equation (4) versus IQ phase difference (Δφ_{IQ}) for four dispersion pre-compensation levels of 1,000 picosecond ps/nm (indicated using circle markers), 3,000 ps/nm (indicated using square markers), 5,000 ps/nm (indicated using triangle markers), and 10,000 ps/nm (indicated using dot markers). The intensity values (on the y-axis) are shown in dBm and the IQ phase difference values are shown as multiples of π. The curves show a dip that reflects a pronounced minimum in RF power in all dispersion pre-compensation levels. The minimum for all levels is also close to the minimum zero in the case of the first curve for the term cos²(θ), which may be ideally achieved when γ in equation (4) is zero. This indicates that using the term ΔI(t) of equation (4) for bias control feedback may be suitable for 16 QAM and other relatively high QAM modulation formats with varying dispersion pre-compensation levels due to the improved control sensitivity of the term ΔI(t), i.e., the presence of a pronounce minimum close to zero at π/2 phase difference.

FIG. 9B shows a graph 900B that comprises the same curves of the graph 900A, but at a closer range at the bottom of the y-axis to show more clearly the dips of the six curves above. The sensitivity of the curves above using the term ΔI(t) for 16 QAM with dispersion pre-compensation may be higher than the sensitivity using the RF power for QPSK without dispersion pre-compensation, e.g., that is represented by the diamond marked curve in in FIG. 2. The bottom of the RF power curve in FIG. 2 for QPSK without dispersion pre-compensation is shallower than the curves in FIGS. 8A and 8B, which indicates lower sensitivity to the phase difference Δφ_{IQ} in FIG. 2, i.e., more difficulty in reaching or maintaining the π/2 phase difference value at the minimum of the curve.

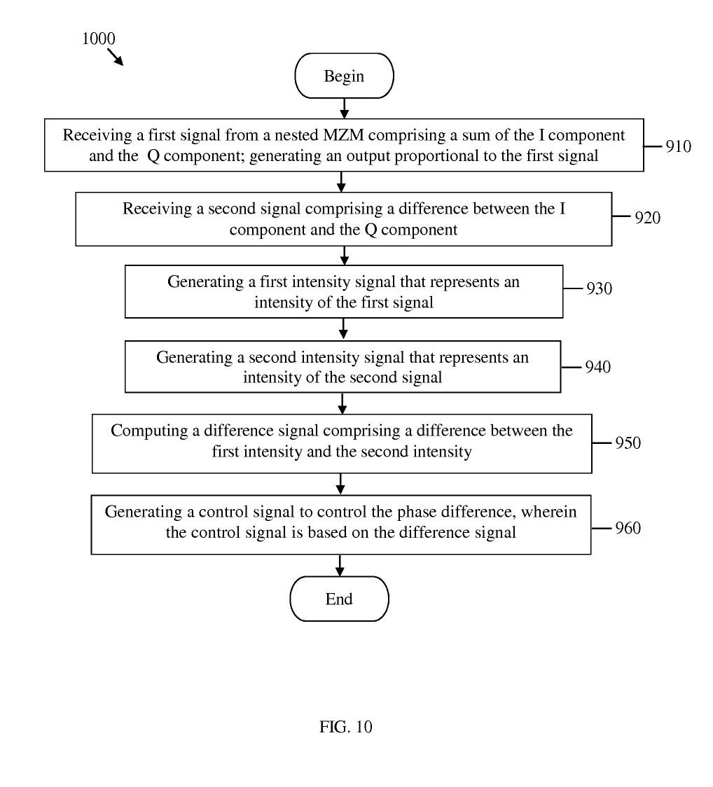

FIG. 10 illustrates a flowchart of a method 1000 for nested MZM phase difference control according to an embodiment, which may have improved sensitivity of detected signals to phase difference and hence improved bias control feedback. The phase difference sensitivity and bias control feedback may be improved by eliminating or substantially reducing the optical intensity fluctuation in the detected output of the MZM apparatus. This may be achieved by detecting the intensity difference between a first signal comprising a sum of I and Q components and a second signal comprising a difference between the I and Q components, e.g., the term ΔI(t) in equation (4). For instance, the method 1000 may be implemented using the MZM apparatus 600 or an apparatus that provides a variance of the intensity difference ΔI(t) via digital signal processing.

The method 1000 may start at block or step 910, where in which a first signal may be received from a nested MZM, such as nested MZM 610 in FIG. 6, or more specifically, from splitter 619, comprising a sum of the I component and the Q component. Also in step 910, an output signal may be generated that is proportional to the first signal. For example, the output signal may be a second output from splitter 619. In step 920, a second signal may be received from the nested MZM, comprising a difference between the I component and the Q component. Such a signal may be received from coupler 618, as an example. In step 930, a first intensity signal may be generated that represents an intensity of the first signal, e.g., as represented by I₁(t) in equation (2). In step 940, a second intensity signal may be generated that represents an intensity of the second signal, e.g., as represented by I₂(t) in equation (3). In step 950, a difference signal may be computed comprising a difference between the first intensity and the second intensity. Step 950 may be performed using op-amp 623, for example. In step 960, a control signal to control the phase difference may be generated, where the control signal may be based on the difference signal. Step 960 may be performed by RF power detector 630 and control 640, for example. For instance, the generated signal proportional to the intensity difference may be measured using the RF power detector 630 that provides a feedback signal to adjust the bias voltage of the MZM according to the measured value. The steps of the method 1000 may be repeated, e.g., in a continuous matter, during the operation of an MZM apparatus and transmission of I and Q components. The method 1000 may then end.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term about means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
a circuit configured to couple to a nested Mach-Zehnder modulator (MZM), the circuit configured to:
receive a first signal that is proportional to a sum of an in-phase (I) component and a quadrature (Q) component;
receive a second signal that is proportional to a difference between the I component and the Q component; and
generate a difference signal as a difference in intensity between the first signal and the second signal; and
a controller configured to provide a bias signal to the nested MZM to control a phase difference between the I component and the Q component, wherein the bias signal is based on the difference signal.

2. The apparatus of claim 1, wherein the bias signal is computed to achieve a minimum of the difference signal.

3. The apparatus of claim 2, wherein a minimum of the difference signal occurs at a phase difference of π/2.

4. The apparatus of claim 1, further comprising:
the nested MZM, wherein the nested MZM comprises:
a first MZM configured to generate the I component;
a second MZM configured to generate the Q component; and
an electrode configured to receive the bias signal.

5. The apparatus of claim 4, further comprising:
a two-by-two coupler configured to receive the I component and the Q component and generate the second signal at one output and a third signal comprising a sum of the I component and the Q component;
a splitter configured to receive the third signal and generate the first signal and an output signal that is proportional to the first signal,
wherein the circuit comprises:
a first photodiode (PD) coupled to the coupler, wherein the first PD is configured to receive the first signal and generate a first intensity signal representing a power of the first signal;
a second PD coupled to the splitter, wherein the second PD is configured to receive the second signal and generate a second intensity signal representing a power of the second signal; and
an operational amplifier (op-amp) coupled to the first PD and the second PD and configured to receive the first intensity signal and the second intensity signal and generate the difference signal.

6. The apparatus of claim 5, wherein the circuit further comprises:
a first amplifier positioned between the first PD and the op-amp and configured to amplify the first intensity signal using a first gain; and
a second amplifier positioned between the second PD and the op-amp and configured to amplify the second intensity signal using a second gain,
wherein the first gain and the second gain are selected to substantially eliminate terms in the difference signal that do not depend on the phase difference.

7. The apparatus of claim 6, wherein the output signal is a quadrature phase-shift keying (QPSK) signal, and wherein a target phase difference between the I component and the Q component is equal to a π/2.

8. The apparatus of claim 6 wherein the output signal is a quadrature amplitude modulation (QAM) signal, and wherein a target phase difference between the I component and the Q component is equal to a π/2.

9. An apparatus comprising:
a nested Mach-Zehnder modulator (MZM) configured to:
generate a first signal comprising a sum of an in-phase (I) component and a quadrature (Q) component;
generate a second signal comprising a difference of the I component and the Q component; and
receive a bias signal that biases a phase difference between the I component and the Q component; and
a circuit coupled to the nested MZM and configured to:
receive the first signal and the second signal;
generate a first intensity signal that represents an intensity of the first signal;
generate a second intensity signal that represents an intensity of the second signal; and
compute a difference signal comprising a difference between the first intensity and the second intensity,
wherein the bias signal is based on the difference signal.

10. The apparatus of claim 9, wherein the apparatus further comprises:
a two-by-two coupler configured to receive the I component and the Q component and generate the second signal at one output and a third signal comprising a sum of the I component and the Q component; and
a splitter configured to receive the third signal and generate the first signal and an output proportional to the first signal,
wherein the circuit comprises:
a first photodiode (PD) coupled to the coupler, wherein the first PD is configured to generate the first intensity;
a second PD coupled to the splitter, wherein the second PD is configured to generate the second intensity; and
an operational amplifier (op-amp) coupled to the first PD and the second PD and configured to receive the first intensity and the second intensity and generate the difference signal as a difference between the first intensity and the second intensity.

11. The apparatus of claim 10, wherein the circuit further comprises:
a first amplifier positioned between the first PD and the op-amp and configured to amplify the first intensity using a first gain; and
a second amplifier positioned between the second PD and the op-amp and configured to amplify the second intensity using a second gain,
wherein the first gain and the second gain are selected to substantially eliminate terms in the difference signal that do not depend on the phase difference.

12. The apparatus of claim 11, wherein the nested MZM comprises:
a first MZM configured to generate the I component;
a second MZM configured to generate the Q component; and
an electrode configured to receive the bias signal.

13. The apparatus of claim 12, further comprising:
a radio frequency (RF) power detector coupled to an output of the op-amp and configured to receive the difference signal and generate a power signal that is proportional to the power of the difference signal; and
a controller configured to receive the power signal and generate the bias signal.

14. The apparatus of claim 13, wherein bias signal is computed to drive the power signal to a minimum value.

15. The apparatus of claim 13, wherein the output is a quadrature phase-shift keying (QPSK) modulated signal, and wherein the bias signal is computed to produce a target phase difference between the I component and the Q component equal to a π/2.

16. The apparatus of claim 13, wherein output is a quadrature amplitude modulation (QAM) modulated signal, and the bias signal is computed to produce a target phase difference between the I component and the Q component equal to a π/2.

17. A method for controlling a phase difference between an in-phase (I) component and a quadrature (Q) component in a nested Mach-Zehnder modulator (MZM), the method comprising:
receiving a first signal from the nested MZM comprising a sum of the I component and the Q component;
receiving a second signal comprising a difference between the I component and the Q component;
generating a first intensity signal that represents an intensity of the first signal;
generating a second intensity signal that represents an intensity of the second signal;
computing a difference signal comprising a difference between the first intensity and the second intensity; and
generating a control signal to control the phase difference, wherein the control signal is based on the difference signal.

18. The method of claim 17, further comprising generating a radio frequency (RF) power signal, wherein the RF power signal represents the RF power of the difference signal, wherein the RF power signal is proportional to cos²(θ), where θ equals the phase difference, and wherein the control signal is generated to drive θ to π/2.

19. The method of claim 18, further comprising:
using the nested MZM to generate the first signal; and
generating an output signal proportional to the first signal,
wherein the output signal is a phase-shift keying (PSK) modulated signal.

20. The method of claim 18, further comprising:
using the nested MZM to generate the first signal; and
generating an output signal proportional to the first signal,
the output signal is a quadrature amplitude modulation (QAM) signal.
